(19) United States
(12) Patent Application Publication
(10) Pub. No.: US 2026/0269155 A1
(43) Pub. Date: Sep. 10, 2026

(54) SLIDE SWITCH MECHANISM, SLIDE SWITCH, AND OPERATION LEVER DEVICE INCLUDING SAME

(71) Applicant: KAWASAKI JUKOGYO KABUSHIKI KAISHA, Kobe-shi, Hyogo (JP)

(72) Inventors: Takanori YASUNAGA, Kobe-shi (JP); Hiroaki SHIMIZU, Kobe-shi (JP); Takumi YAMAZAKI, Kobe-shi (JP)

(21) Appl. No.: 19/162,319

(22) PCT Filed: Jan. 11, 2024
(86) PCT No.: PCT/JP2024/000464

§ 371 Date: Sep. 4, 2025

(30) Foreign Application Priority Data
Mar. 7, 2023 (JP) 2023-034599

(51) Int. Cl. H01H 15/10; H01H 9/02; H01H 15/16

(52) U.S. Cl. CPC H01H 15/10; H01H 9/02; H01H 15/16

(57) ABSTRACT

A slide switch mechanism includes: a housing including: a housing body, an opening portion, and an inner cover portion; and a slide member including a slide body and an operation portion. The housing body is separable in a predetermined direction into first and second housing parts. The first housing part includes: a body portion having the opening portion and the inner cover portion, and an insertion path extending on one side in a circumferential direction from the opening portion; and a lid portion attached to the body portion to close the insertion path. The second housing part is joined to the first housing part from the other side in the predetermined direction. The slide member causes the operation portion to pass through the insertion path from the one side in the circumferential direction and is joined to the first housing part with the lid portion detached from the body portion.

### TECHNICAL FIELD

The present disclosure relates to a slide switch mechanism and a slide switch that are slidable, and an operation lever device including the slide switch.

### BACKGROUND ART

In operation levers for construction equipment and other various devices, a slide switch is used. As an example of the slide switch, the rotary control device disclosed in Patent Literature (PTL) 1 is known, for example. In the rotary control device disclosed in PTL 1, a movable actuation portion is configured to be rotatable (in other words, slidable) about an axis.

### CITATION LIST

### Patent Literature

PTL 1: Japanese Laid-Open Patent Application Publication (Japanese Translation of PCT Publication) No. 2008-529144

### SUMMARY OF INVENTION

### Technical Problem

The rotary control device disclosed in PTL 1 does not include, in itself, a member that surrounds the movable actuation portion; when the rotary control device is attached to a handle, the movable actuation portion is covered. Therefore, in the rotary control device, a casing is formed separately from the handle. Furthermore, in the rotary control device, a shaft and the movable actuation portion are also formed separately. Therefore, there are a large number of components in the rotary control device. Meanwhile, in order to reduce the number of components, the components may be partially integrated; for example, an upper portion of the casing and the handle may be integrated. However, if these are integrated, the following situation occurs. Specifically, the movable actuation portion needs to be rotated and inserted between the upper portion of the casing and the handle. Meanwhile, since the movable actuation portion includes an operation portion in the form of a projection, the operation portion will come into contact with the handle during the rotation and insertion. Therefore, the movable actuation portion (in other words, a slide member) cannot be easily joined to the casing (that is, a housing).

Thus, an object of the present disclosure is to provide a slide switch mechanism, a slide switch, and an operation lever device in which the number of components is minimized and a slide member is easily joined.

### Solution to Problem

A slide switch mechanism according to the present disclosure includes: a housing including: a housing body formed to be hollow; an opening portion formed in a ceiling portion of the housing body that is located on one side in a predetermined direction; and an inner cover portion formed inside the housing body to face the ceiling portion and extending in a circumferential direction around a rotation axis passing through the housing body, the inner cover portion being arc-shaped; and a slide member including: a slide body disposed to be rotatable about the rotation axis between the inner cover portion and the ceiling portion; and an operation portion provided on the slide body to project on the one side of the opening portion in the predetermined direction. The housing body is configured to be separable in the predetermined direction into a first housing part and a second housing part. The first housing part includes: a body portion in which the opening portion and the inner cover portion are formed and an insertion path is formed extending on one side in the circumferential direction from the opening portion; and a lid portion that is attached to the body portion to close the insertion path. The second housing part is joined to the first housing part from the other side in the predetermined direction. The slide member causes the operation portion to pass through the insertion path from the one side in the circumferential direction and is joined to the first housing part with the lid portion detached from the body portion.

In the slide switch mechanism according to the present disclosure, the insertion path extending on the one side in the circumferential direction from the opening portion is formed in the body portion of the first housing part. The slide member causes the operation portion to pass through the insertion path from the one side in the circumferential direction and is joined to the first housing part with the lid portion detached from the body portion. Thus, the slide member is joined to the housing as follows, for example. Specifically, the slide member is joined to the housing by rotating about the rotation axis along the inner cover portion. In other words, when the slide member rotates in the other circumferential direction along the inner cover portion, the operation portion is sent toward the opening portion through the insertion path. Thereafter, the lid portion is attached to the body portion and as a result, the insertion path is closed. Furthermore, the second housing part is joined to the first housing part from the other side in the predetermined direction. In this manner, the slide member can be joined to the housing and thus, the slide switch mechanism in which the slide member includes the operation portion can be easily assembled while the increase in the number of components therein is suppressed. In other words, when the inner cover portion is formed in the first housing part, it is possible to easily assemble the slide switch mechanism in which the slide member includes the operation portion while suppressing the increase in the number of components therein.

A slide switch according to the present disclosure is a slide switch including: the slide switch mechanism described above; and a sensor mechanism that detects an amount of rotation of the slide member. The slide switch mechanism further includes a biasing member that biases, in the circumferential direction, the slide member that rotates from a neutral position that is predetermined, and brings the slide member back to the neutral position.

The slide switch according to the present disclosure includes: the above-described slide switch mechanism further including a spring member; and the sensor mechanism. Therefore, the slide switch including the above-described functions can be realized.

An operation lever device according to the present disclosure is an operation lever device including: an operation lever extending in a predetermined direction and pivotally supported at an end on one side in the predetermined direction; and the slide switch described above. The slide switch is disposed in an area on the operation lever that is located on the other side in the predetermined direction.

The operation lever device according to the present disclosure includes the above-described slide switch disposed in an area on the operation lever that is located on the other side in the predetermined direction. Therefore, the operation lever device including the above-described functions can be realized.

### Advantageous Effects of Invention

In a slide switch mechanism, a slide switch, and an operation lever device according to the present disclosure, the number of components is minimized and a slide member is easily joined.

The above object, other objects, features, and advantages of the present disclosure will be made clear by the following detailed explanation of preferred embodiments with reference to the attached drawings.

### BRIEF DESCRIPTION OF DRAWINGS

FIG. 1 is a perspective view illustrating an operation lever device including a slide switch according to the present embodiment.

FIG. 2 is a perspective view illustrating the slide switch of FIG. 1.

FIG. 3 is a cross-sectional view of the slide switch of FIG. 2 taken along cut plane X.

FIG. 4 is a cross-sectional view of the slide switch taken along cut line IV-IV indicated in FIG. 3.

FIG. 5 is an exploded view illustrating the slide switch of FIG. 2 in a disassembled state.

FIG. 6 is a plan view of the slide of FIG. 2 viewed from one side in a predetermined direction.

FIG. 7 is a cross-sectional view of the slide switch with an operation portion having rotated through a predetermined limit angle, taken along cut line VI-VI indicated in FIG. 3.

FIG. 8 is a cross-sectional view illustrating each state where a slide member is being incorporated into a body portion of a first housing part.

FIG. 9 is a cross-sectional view illustrating each state where a lid portion is being joined to a body portion of a first housing part.

### DESCRIPTION OF EMBODIMENTS

Hereinafter, a slide switch 1, a slide switch mechanism 11, and an operation lever device 2 according to an embodiment of the present disclosure will be described with reference to the aforementioned drawings. Note that the concept of directions mentioned in the following description is used for the sake of explanation; the orientations, etc., of elements according to the present disclosure are not limited to these directions. The slide switch 1, the slide switch mechanism 11, the operation lever device 2 described below are merely one embodiment of the present disclosure. Thus, the present disclosure is not limited to the embodiments and may be subject to addition, deletion, and alteration within the scope of the essence of the present disclosure.

### Operation Lever Device

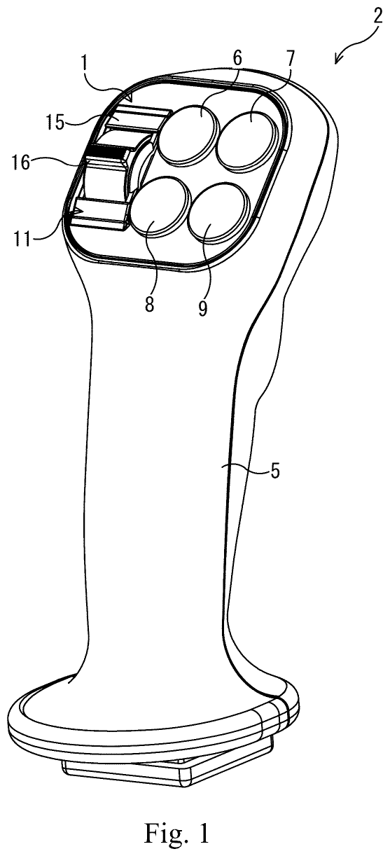

The operation lever device 2 illustrated in FIG. 1 is provided, for example, in work vehicles including construction vehicles such as excavators and cranes and industrial vehicles such as forklifts. The operation lever device 2 is provided on the driver seat or the like of a work vehicle. More specifically, the operation lever device 2 is pivotally supported on a base included in a cabin and not illustrated in the drawings. An operator of the work vehicle, such as a driver, can operate various elements of the work vehicle by gripping and moving the operation lever device 2. The operation lever device 2 includes an operation lever 5, a plurality of switches 6 to 9, and the slide switch 1.

The operation lever 5, which is a hollow rod-shaped member extending in a predetermined direction, is designed to be grippable. Furthermore, the operation lever 5 is pivotally supported at a portion on one side in the predetermined direction (one end in the predetermined direction in the present embodiment) on the base not illustrated in the drawings. The operation lever 5 is operated to tilt in various directions (for example, all directions including the front-back or depth direction and the left-right or horizontal direction).

The plurality of switches 6 to 9 are arranged in an area on the operation lever 5 that is located on the other side in the predetermined direction. In the present embodiment, four switches 6 to 9 are arranged on a portion of the operation lever 5 that is located at the other end in the predetermined direction. The four switches 6 to 9 are, for example, button switches, and are arranged in two columns on the portion of the operation lever 5 that is located at the other end in the predetermined direction. When pressed (in other words, operated), each of the four switches 6 to 9 outputs a signal.

### Slide Switch

The slide switch 1 is also disposed in the area on the operation lever 5 that is located on the other side in the predetermined direction. In the present embodiment, the slide switch 1 is disposed on one side of the four switches 6 to 9 in the direction of the columns thereof. The slide switch 1, which is a magnetic switch, is configured as follows.

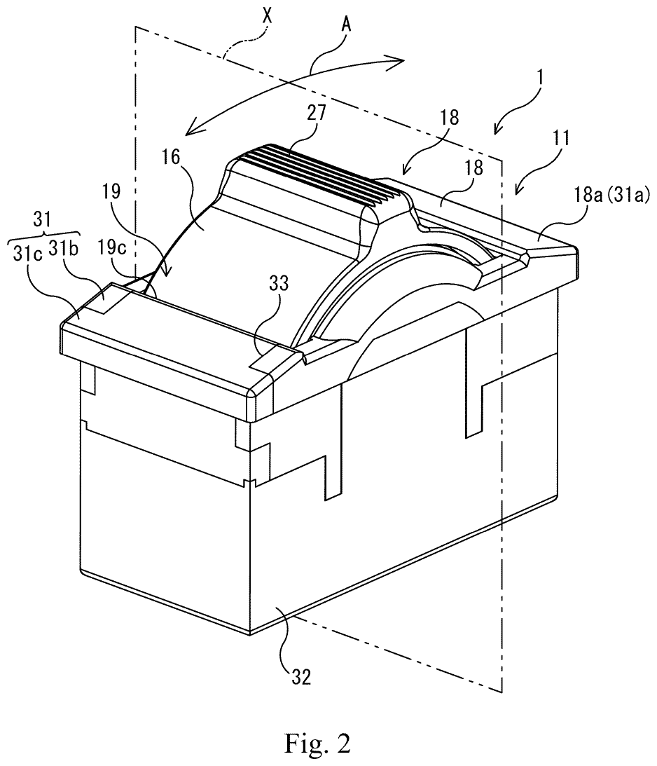

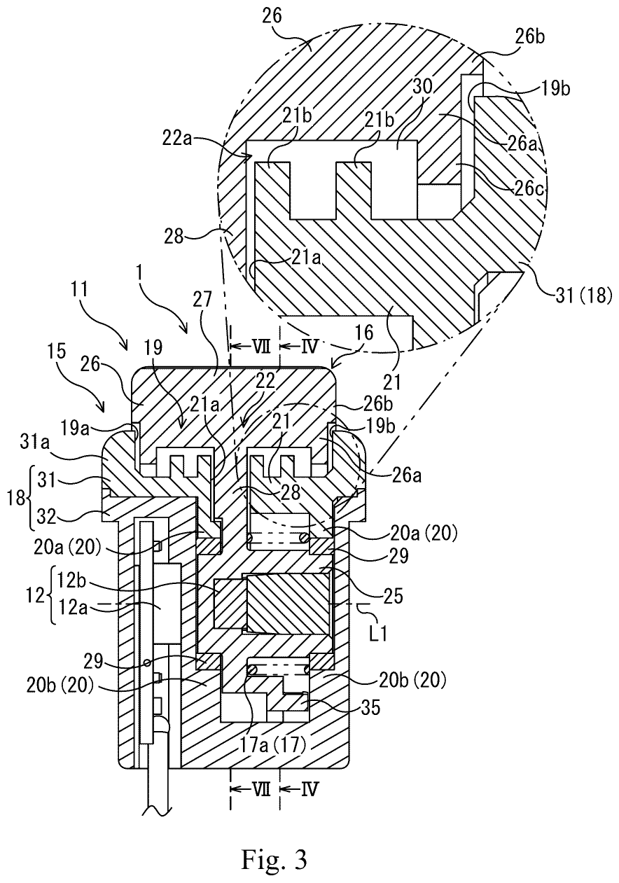

Specifically, the slide switch 1 is configured to be slidable (refer to the arrow A), as illustrated in FIG. 2. When the slide switch 1 is operated to be slid, the slide switch 1 outputs a signal. The slide switch 1 includes a slide switch mechanism 11 and a sensor mechanism 12, as illustrated in FIG. 3.

### Slide Switch Mechanism

The slide switch mechanism 11 is configured to be slidable (refer to the arrow A), as illustrated in FIG. 2. The slide switch mechanism 11 includes a housing 15, a slide member 16, and a spring member 17, as illustrated in FIG. 3 to FIG. 5.

### Housing

The housing 15 houses the sensor mechanism 12, the slide member 16, and the spring member 17. Furthermore, the housing 15 includes a housing body 18, an opening portion 19, a shaft support 20, and an inner cover portion 21.

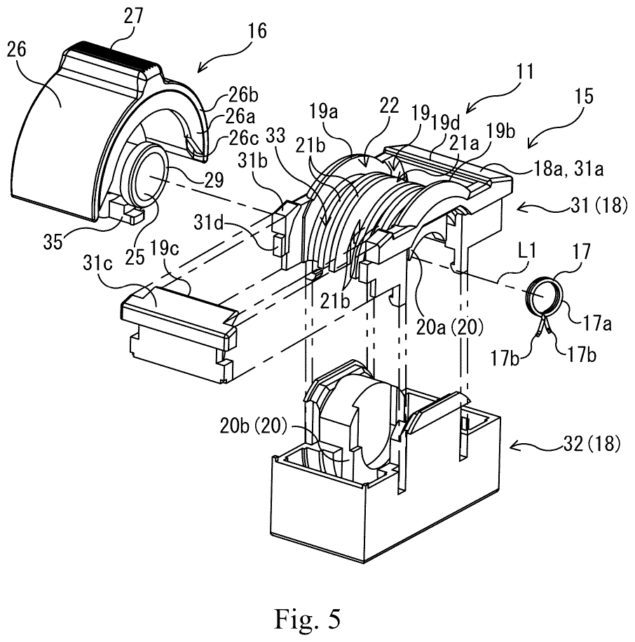

The housing body 18 is formed to be hollow. The housing body 18 is formed in the shape of a rectangular box having a height in the predetermined direction, for example. The housing body 18 includes a first housing part 31 and a second housing part 32, as illustrated in FIG. 5. The first housing part 31 constitutes a part of the housing body 18 that is located on the one side in the predetermined direction. The second housing part 32 constitutes a part of the housing body 18 that is located on the other side in the predetermined direction. The housing body 18 is configured to be separable in a predetermined direction (that is the vertical direction in the present embodiment) into the first housing part 31 and the second housing part 32.

More specifically, the first housing part 31 is formed in the shape of a hollow rectangular parallelepiped that is open on the other side in the predetermined direction. The second housing part 32 is formed in the shape of a hollow rectangular parallelepiped that is open at least on the one side in the predetermined direction. The second housing part 32 can be joined to the first housing part 31 from the other side in the predetermined direction. When the second housing part 32 is joined to the first housing part 31, these housing parts engage each other and constitute the housing body 18.

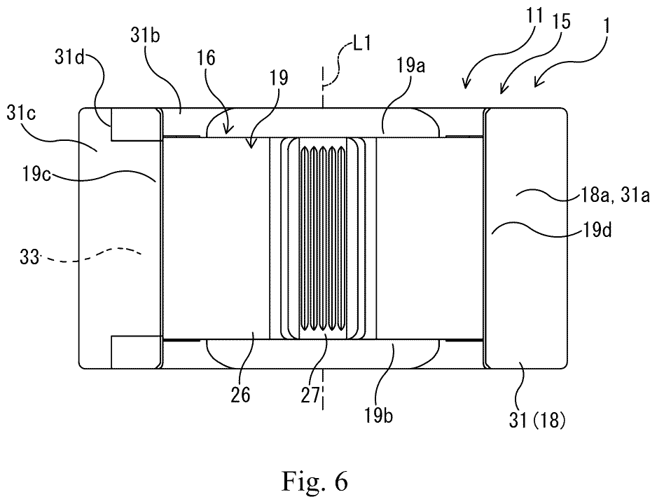

The opening portion 19 is formed in a ceiling portion (in the present embodiment, an upper end portion) 18a which is an end of the housing body 18 that is located on the one side in the predetermined direction, as illustrated in FIG. 2. More specifically, the opening portion 19 is formed in a ceiling portion (in the present embodiment, an upper end portion) 31a of the first housing part 31. In the ceiling portion 31a, the opening portion 19 extends in the longitudinal direction (or the circumferential direction to be described in detail later). In the present embodiment, the opening portion 19 is formed in the shape of a rectangle, for example, in plan view seen from the one side in the predetermined direction, as illustrated in FIG. 6.

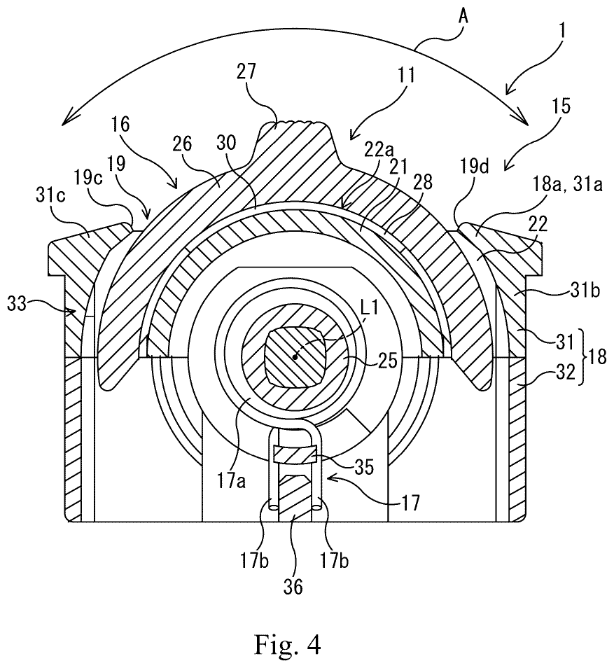

The shaft support 20 is formed about a predetermined rotation axis L1 inside the housing body 18, as illustrated in FIG. 3 and FIG. 4. The rotation axis L1 is an axis passing through the housing body 18. More specifically, the rotation axis L1 is an axis extending in a direction perpendicular to the predetermined direction. In the present embodiment, the rotation axis L1 passes through the center of the housing body 18 and extends in the transverse direction. The shaft support 20 is configured as follows.

Specifically, a shaft part 25 to be described in detail later is inserted through the shaft support 20. The shaft support 20 supports the shaft part 25 in such a manner that the shaft part 25 can rotate about the rotation axis L1. In the present embodiment, the shaft support 20 supports the axially opposite ends of the shaft part 25. The shaft support 20 includes: a first portion 20a formed on the first housing part 31; and a second portion 20b formed on the second housing part 32. The first portion 20a and the second portion 20b, each of which is formed in the shape of an arc around the rotation axis L1, are arranged on the one side and the other side of the rotation axis L1 in the predetermined direction. The first portion 20a and the second portion 20b are arranged facing each other in the predetermined direction. Therefore, the first portion 20a and the second portion 20b constitute the shaft support 20 when the second housing part 32 is joined to the first housing part 31.

The inner cover portion 21 is formed inside the housing body 18 to face the ceiling portion 18a. More specifically, the inner cover portion 21 is formed inside the first housing part 31 to face the ceiling portion 31a. In the present embodiment, the inner cover portion 21 is disposed facing the opening portion 19. The inner cover portion 21 is in the shape of an arc extending in the circumferential direction around the rotation axis L1. More specifically, the inner cover portion 21 is formed in the shape of a semicircle, for example. Note that the shape of the inner cover portion 21 is not limited to a semicircle. The inner cover portion 21 covers the shaft support 20 from the one side in the predetermined direction. As a result, the inner cover portion 21 protects the shaft support 20 from contaminants entering through the opening portion 19. Furthermore, an insertion groove 21a to be described in detail later is formed on the inner cover portion 21.

Furthermore, when the inner cover portion 21 is formed inside the first housing part 31 to face the ceiling portion 18a of the housing body 18, a slide space 22 described below is formed. The slide space 22, which is a space formed between the ceiling portion 18a of the housing body 18 and the inner cover portion 21, is formed in the shape of an arc centered on the rotation axis L1. In the present embodiment, the slide space 22 is formed in the shape of a semicircle. The slide space 22 is connected to the opening portion 19 on the one side in the predetermined direction. At least part of the slide space 22 faces the outside through the opening portion 19.

### Slide Member

The slide member 16 is disposed inside the housing body 18 to be rotatable about the rotation axis L1. More specifically, the slide member 16 is disposed between the ceiling portion 18a of the housing body 18 and the inner cover portion 21, that is, in the slide space 22, in such a manner that the slide member 16 can rotate about the rotation axis L1. A thumb or other fingers can be pressed against the slide member 16. By pushing and pulling (in other words, sliding) the slide member 16 with a finger, the sliding member 16 rotates (in other words, slides) about the rotation axis L1. The slide member 16 includes the shaft part 25, a slide body 26, and an operation portion 27.

The shaft part 25 is supported on the shaft support 20 to be rotatable about the rotation axis L1. The shaft part 25 is formed in the shape of a circular column, for example. The shaft part 25 is inserted through the shaft support 20 and is supported thereon. More specifically, a bearing 29 fits on each of the axially opposite ends of the shaft part 25 in the present embodiment. The axially opposite ends of the shaft part 25 are supported on the shaft support 20 via the bearings 29. Therefore, the shaft part 25 can rotate about the rotation axis L1. The shaft part 25 rotates about the rotation axis L1 in conjunction with the slide body 26 as will be described in detail later.

The slide body 26 is disposed in the slide space 22 to be rotatable about the rotation axis L1. More specifically, the slide body 26 is formed in the shape of an arc extending in the circumferential direction as with the inner cover portion 21. The slide body 26 is inserted into the slide space 22 in such a manner that a portion of the slide body 26 projects through the opening portion 19 in the present embodiment. The slide body 26 rotates around the rotation axis L1 inside the slide space 22. Note that in the slide space 22, the slide body 26 is positioned radially apart from the inner cover portion 21 with spacing 22a therebetween. The slide body 26 extends on the one side and the other side of the slide space 22 in the circumferential direction. In other words, the slide body 26 is formed in the shape of an arc having a central angle greater than the central angle of the inner cover portion 21.

Furthermore, the slide body 26 rotates to cause rotation of the shaft part 25. More specifically, the slide body 26 is connected to the shaft part 25 via a coupling portion 28. In the present embodiment, the coupling portion 28 extends radially outward from the shaft part 25 to the slide body 26, for example. Thus, the coupling portion 28 couples the shaft part 25 and the slide body 26 to each other. In the inner cover portion 21, the insertion groove 21a is formed at a position corresponding to the coupling portion 28. The insertion groove 21a extends in the circumferential direction from one circumferential end to the other circumferential end of the inner cover portion 21, for example. The coupling portion 28 is inserted through the insertion groove 21a and can move in the circumferential direction in the insertion groove 21a. Thus, when the slide body 26 rotates, the shaft part 25 rotates via the coupling portion 28. The coupling portion 28 is formed so that the distance between the coupling portion 28 and the insertion groove 21a becomes small. More specifically, the coupling portion 28 is formed so that the width thereof (the length thereof in the axial direction, that is, the transverse direction in the present embodiment) becomes substantially equal to the width of the insertion groove 21a. As a result, the spacing between the coupling portion 28 and the insertion groove 21a is small.

The slide body 26 is disposed so that the distance between the slide body 26 and the ceiling portion 18a of the housing body 18 becomes small. More specifically, the inner peripheral surface of the ceiling portion 18a of the housing body 18 is formed of a curved surface centered on the rotation axis L1. The slide body 26 is formed so that the outer diameter thereof becomes substantially equal to the radius of curvature of the inner peripheral surface of the ceiling portion 18a. Therefore, the spacing between the slide body 26 and the ceiling portion 18a is small.

The slide body 26 includes an outer peripheral edge portion 26b formed to be wider in the axial direction than an inner peripheral edge portion 26a on axially opposite side surfaces, as illustrated in FIG. 3. The outer peripheral edge portion 26b of the slide body 26 is exposed on the one side in the predetermined direction in the opening portion 19. In other words, the slide body 26 has the outer peripheral edge portion 26b projecting on the one side in the predetermined direction from the opening portion 19 (refer also to FIG. 2 and FIG. 4). The outer peripheral edge portion 26b of the slide body 26 covers outer edge portions 19a, 19b of the opening portion 19 that are located at the axially opposite ends thereof. As a result, contaminants such as dust are kept from entering the area between the slide body 26 and the outer edge portions 19a, 19b.

The operation portion 27 is used to operate the slide member 16. The operation portion 27 is provided on the slide body 26. More specifically, the operation portion 27 projects radially outward from a portion of the slide body 26 that is located in the middle thereof in the circumferential direction. The operation portion 27 projects on the one side in the predetermined direction from the opening portion 19. Therefore, a thumb or other fingers can be pressed against the operation portion 27. With the pressed finger being pushed and pulled, the operation portion 27 can cause the slide body 26 to rotate about the rotation axis L1.

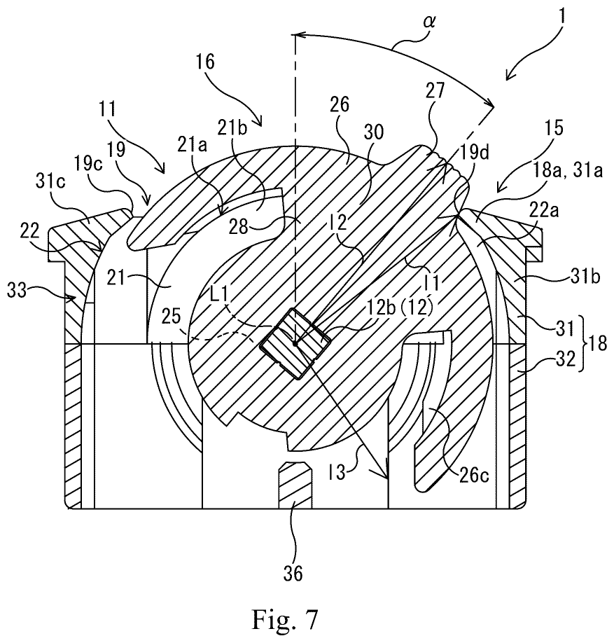

When the slide member 16 rotates through a predetermined limit angle α around the rotation axis L1 as illustrated in FIG. 7, the operation portion 27 abuts the edge portions 19c, 19d located at the circumferentially opposite ends of the opening portion 19. On the other hand, the slide member 16 does not come into contact with the other portions of the housing 15, for example, the second portion 20b of the shaft support 20, during the rotation of the slide body 26 through the predetermined limit angle α around the rotation axis L1. Thus, the edge portions 19c, 19d of the opening portion 19 play the roles of a stopper. As a result, at the time when the rotation of the slide member 16 is restricted, a distance l1 between the operation portion 27, which acts as a point of effort, and the edge portions 19c, 19d, each of which acts as a fulcrum, is smaller than a distance l2 between the shaft part 25, which acts as a point of load, and each of the edge portions 19c, 19d. Therefore, it is possible to reduce a load that acts on the shaft part 25.

### Labyrinth

In the slide switch mechanism 11, the inner cover portion 21 and the slide body 26 form a labyrinth 30 therebetween (that is, in the spacing 22a), as illustrated in the enlarged view in FIG. 3. The labyrinth 30 is formed to meander in a predetermined direction in the space between the inner cover portion 21 and the slide body 26, for example. More specifically, the inner cover portion 21 includes a plurality of first projections 21b, and the slide body 26 includes a plurality of second projections 26c. In the present embodiment, the inner cover portion 21 includes four first projections 21b, and the slide body 26 includes two second projections 26c. The labyrinth 30 is formed by the first projections 21b and the second projections 26c. The projections 21b, 26c will be described in further detail below.

The first projection 21b is formed on a surface of the inner cover portion 21 that faces the slide body 26. The first projections 21b are disposed two on each of the axially opposite ends of the insertion groove 21a and positioned axially spaced apart from each other. The first projection 21b extends in the circumferential direction and projects toward the slide body 26. The second projection 26c is formed on a surface of the slide body 26 that faces the inner cover portion 21. The second projection 26c is positioned next to the first projection 21b and axially spaced apart therefrom. The second projections 26c are disposed sandwiching the four first projections 21b from the one side and the other side in the axial direction, for example. In the present embodiment, the second projections 26c are formed at the axially opposite ends of the slide body 26, for example. Note that the second projection 26c may be disposed between the two first projections 21b that are located next to each other. The second projection 26c extends in the circumferential direction and projects toward the inner cover portion 21. Therefore, with the first projections 21b and the second projections 26c that are located close to each other, the space between the inner cover portion 21 and the slide body 26 is formed into a meandering shape; in other words, the labyrinth 30 is formed between the inner cover portion 21 and the slide body 26. As a result, contaminants passing between the inner cover portion 21 and the slide body 26 are caught therein, in other words, kept from reaching the insertion groove 21a. The inner cover portion 21 is formed in the shape of an arc. Therefore, the contaminants caught in the labyrinth 30 are sent along the inner cover portion 21 to fall off on the one side or the other side in the predetermined direction when the slide body 26 rotates. Thus, the contaminants are further kept from reaching the insertion groove 21a.

Furthermore, the first housing part 31 is configured as follows. Specifically, the first housing part 31 includes a body portion 31b and a lid portion 31c, as illustrated in FIG. 5. In the body portion 31b, the opening portion 19, the shaft support 20, and the inner cover portion 21 are formed. The body portion 31b is formed in the shape of the letter “U” in plan view seen from the one side in the predetermined direction, for example. More specifically, the opening portion 19 is formed in the ceiling portion 31a of the body portion 31b, and the shaft support 20 and the inner cover portion 21 are formed in the body portion 31b. Furthermore, an insertion path 33 is formed on the body portion 31b.

The insertion path 33 extends on one side in the circumferential direction from the opening portion 19. The insertion path 33 is formed to allow the operation portion 27 to pass therethrough from the one side in the circumferential direction. More specifically, the insertion path 33 extends from the opening portion 19 to a side surface 31d of the housing body 18 through the ceiling portion 31a of the first housing part 31. The insertion path 33 is open on the one side in the predetermined direction on the side surface 31d of the first housing part 31. Therefore, the body portion 31b is formed in the shape of the letter “U” that is open on the one side in the circumferential direction in plan view seen from the one side in the predetermined direction. The lid portion 31c is attached to the body portion 31b to close the insertion path 33 (refer to FIG. 2). The lid portion 31c is detachably attached to the body portion 31b. The insertion path 33 is not closed, in other words, the insertion path 33 is open, when the lid portion 31c is not attached to the body portion. Therefore, the operation portion 27 can pass through the insertion path 33. Thus, the slide member 16 causes the operation portion 27 to pass through the insertion path 33 from the one side in the circumferential direction and is joined to the first housing part 31 with the lid portion 31c detached from the body portion 31b.

### Spring Member

The spring member 17, which is an example of the biasing member illustrated in FIG. 4, biases, to the one side or the other side in the circumferential direction, the slide member 16 that rotates from a predetermined neutral position. Thus, the slide member 16 is brought back to the neutral position by the spring member 17. The neutral position is the position of the slide member 16 at which the operation portion 27 assumes a predetermined posture. In the present embodiment, the neutral position represents the state where the operation portion 27 is upright on the one side in the predetermined direction. Note that the neutral position is not limited to representing the state where the operation portion 27 assumes the aforementioned posture and may represent the state where the operation portion 27 is tilted. Furthermore, the neutral position is not limited to representing the posture of the operation portion 27 and may be defined by the circumferential position of the operation portion 27.

The spring member 17 is a torsion coil spring in the present embodiment. Furthermore, the spring member 17 includes a coil 17a and a pair of arms 17b, 17b, for example. In the spring member 17, the coil 17a is provided on the exterior of the shaft part 25. The pair of arms 17b, 17b extend on the other side in the predetermined direction from the coil 17a. The pair of arms 17b, 17b are positioned circumferentially spaced apart from each other. In the slide member 16, an actuating portion 35 is formed to correspond to the pair of arms 17b, 17b. Furthermore, in the second housing part 32, a fixing portion 36 is formed to correspond to the pair of arms 17b, 17b. Both the actuating portion 35 and the fixing portion 36 are disposed between the pair of arms 17b, 17b.

The spring member 17 configured as described above operates as follows. Specifically, when the slide member 16 rotates in one circumferential direction, the actuating portion 35 causes one arm 17b of the spring member 17 to move in the one circumferential direction. On the other hand, the other arm 17b is fixed by the fixing portion 36. As a result, the spring member 17 applies a biasing force to the slide member 16 to bring the slide member 16 back to the neutral position. Similarly, when the slide member 16 rotates in the other circumferential direction, the actuating portion 35 causes the other arm 17b to move in the other circumferential direction. On the other hand, the one arm 17b is fixed by the fixing portion 36. As a result, the spring member 17 applies a biasing force to the slide member 16 to bring the slide member 16 back to the neutral position. In this manner, both when the slide member 16 rotates in the one circumferential direction and when the slide member 16 rotates in the other circumferential direction, the spring member 17 applies the biasing force to the slide member 16 to bring the slide member 16 back to the neutral position.

### Sensor Mechanism

The sensor mechanism 12 illustrated in FIG. 3 detects an amount of operation, that is, an amount of rotation (for example, an angle from the neutral position) of the slide member 16. Subsequently, the sensor mechanism 12 outputs a signal corresponding to the detected amount of rotation. The sensor mechanism 12 is a magnet-based rotation angle sensor in the present embodiment. The sensor mechanism 12 includes a magnet 12a and a detection portion 12b, for example. Note that the sensor mechanism 12 may be a rotation angle sensor other than the magnet-based rotation angle sensor. The magnet 12a is embedded in the shaft part 25. The detection portion 12b is incorporated into the housing body 18 (more specifically, the second housing part 32). Both the magnet 12a and the detection portion 12b are disposed on the rotation axis L1. The detection portion 12b detects the amount of rotation (that is, the amount of angular displacement) of the shaft part 25 on the basis of a change in the magnetic field of the magnet 12a that has occurred during the rotation of the shaft part 25. Subsequently, the detection portion 12b outputs the amount of rotation of the shaft part 25.

### Method for Assembling Slide Switch

Next, a method for assembling the slide switch 1 will be described. First, in the slide switch 1, the magnet 12a is embedded in the shaft part 25. Furthermore, the detection portion 12b is incorporated into the second housing part 32. Note that the embedding of the magnet 12a and the incorporation of the detection portion 12b may occur midway through the assembling work to be described below. When the embedding and incorporating work is completed, the slide switch 1 is assembled as follows, for example.

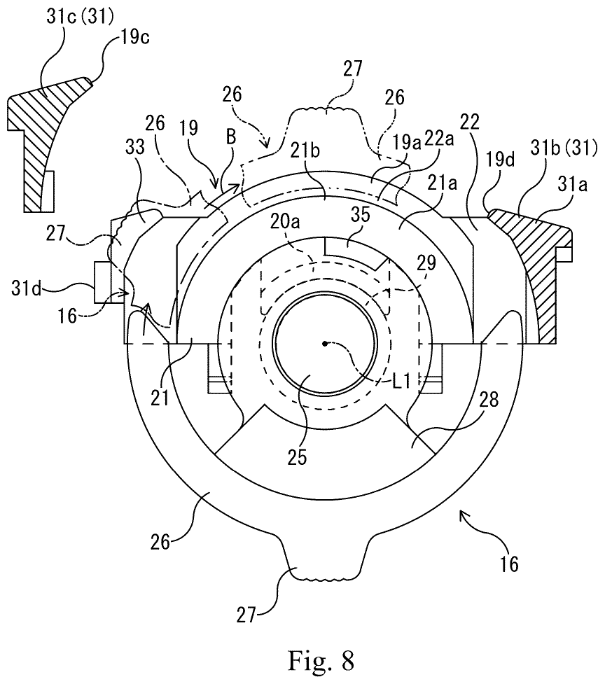

First, the slide member 16 is incorporated into the body portion 31b of the first housing part 31. More specifically, first, in order to incorporate the slide member 16 into the body portion 31b, the shaft part 25 of the slide member 16 is pressed against the first portion 20a from the other side in the predetermined direction (refer to the solid lines in FIG. 8). As a result, an end of the slide body 26 that is located on the other side in the circumferential direction is inserted into the body portion 31b, for example. In other words, an end of the slide body 26 that is located on the other side in the circumferential direction is inserted into the body portion 31b through an opening portion of the body portion 31b that is located on the other side in the predetermined direction. As a result, the end of the slide body 26 that is located on the other side in the circumferential direction overlaps an end of the inner cover portion 21 that is located on the one side in the circumferential direction. Subsequently, the slide body 26 is rotated in the other circumferential direction around the shaft part 25 (refer to the arrow B in FIG. 8). As a result, the end of the slide body 26 that is located on the other side in the circumferential direction moves in the other circumferential direction along the inner cover portion 21.

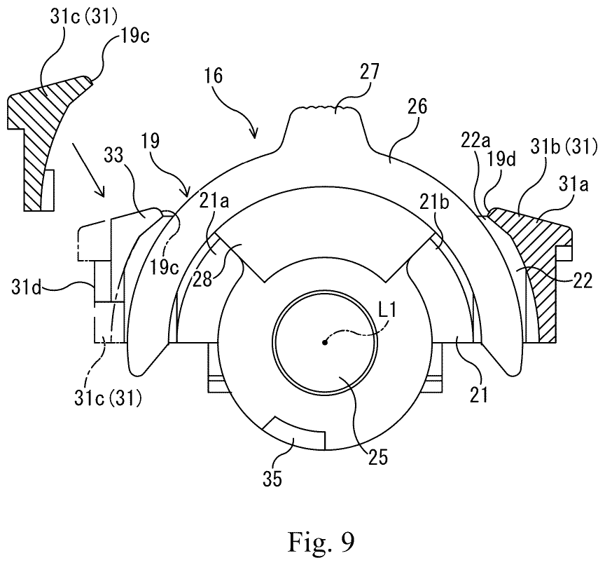

When the slide member 16 rotates, the operation portion 27 eventually enters the insertion path 33 (refer to the dash-dot lines in FIG. 8). When the slide member 16 continues to rotate further, the end of the slide body 26 that is located on the other side in the circumferential direction is inserted between the inner cover portion 21 and the ceiling portion 31a. When the slide member 16 continues to rotate afterwards, the operation portion 27 eventually comes out of the insertion path 33. In other words, the operation portion 27 reaches the opening portion 19 (refer to the dash-dot-dot lines in FIG. 8). When the operation portion 27 reaches the opening portion 19, the lid portion 31c is attached to the body portion 31b (refer to the dash-dot lines in FIG. 9). This means that the insertion path 33 is closed. In this manner, the slide member 16 is incorporated into the first housing part 31. Furthermore, after the slide member 16 is incorporated, the spring member 17 is attached to the shaft part 25. At this time, the actuating portion 35 is inserted between the pair of arms 17b, 17b of the spring member 17.

When the slide member 16 is incorporated into the first housing part 31, then the second housing part 32 is joined to the first housing part 31 (refer to FIG. 4). At this time, the second housing part 32 is joined to the first housing part 31 from the other side in the predetermined direction in such a manner that the fixing portion 36 is inserted between the pair of arms 17b, 17b of the spring member 17. As a result, the slide switch mechanism 11 is assembled. Thus, the slide switch 1 is assembled.

The slide switch 1 assembled in this manner is included in the operation lever device 2 as mentioned above. In the operation lever device 2, an operator grips a portion of the operation lever 5 that is located in the middle thereof in the vertical direction, for example. The operation lever 5 tilts in all directions at 360 degrees on a fulcrum that is a base not illustrated in the drawings. Furthermore, in the operation lever device 2, the switches 1, 6 to 9 are operated with a thumb of an operator, for example. For example, the switches 6 to 9 are operated (for example, pressed) with a thumb. As a result, the switches 6 to 9 output signals. Meanwhile, the slide switch 1 is operated as follows. A thumb or other fingers are pressed against the operation portion 27 of the slide member 16. By pushing and pulling the operation portion 27 with a finger, the sliding member 16 rotates in the one circumferential direction or the other circumferential direction (refer to the arrow A in FIG. 2). This causes a change in the magnetic field of the magnet 12a provided on the shaft part 25. Accordingly, the detection portion 12b outputs a signal corresponding to the amount of rotation of the slide member 16. Thus, the sensor mechanism 12 outputs a signal corresponding to the amount of rotation of the slide member 16.

In the slide switch mechanism 11 according to the present embodiment, the insertion path 33 extending on the one side in the circumferential direction from the opening portion 19 is formed in the body portion 31b of the first housing part 31. The slide member 16 causes the operation portion 27 to pass through the insertion path 33 from the one side in the circumferential direction and is joined to the first housing part 31 with the lid portion 31c detached from the body portion 31b. Thus, the slide member 16 is joined to the housing 15 as follows, for example. Specifically, the slide member 16 is joined to the housing 15 by rotating about the rotation axis L1 along the inner cover portion 21. In other words, when the slide member 16 rotates in the one circumferential direction along the inner cover portion 21, the operation portion 27 is sent toward the opening portion 19 through the insertion path 33. Thereafter, the lid portion 31c is attached to the body portion 31b and as a result, the insertion path 33 is closed. Furthermore, the second housing part 32 is joined to the first housing part 31 from the other side in the predetermined direction. In this manner, the slide member 16 can be joined to the housing 15 and thus, the slide switch mechanism 11 in which the slide member 16 includes the operation portion 27 can be easily assembled while the increase in the number of components therein is suppressed. In other words, when the inner cover portion 21 is formed in the first housing part 31, it is possible to easily assemble the slide switch mechanism 11 in which the slide member 16 includes the operation portion 27 while suppressing the increase in the number of components therein.

Furthermore, in the slide switch mechanism 11 according to the present embodiment, the slide member 16 further includes the shaft part 25 that pivots on the shaft support 20 to be rotatable about the rotation axis L1 and rotates in conjunction with the slide body 26. The shaft support 20 includes: a first portion 20a formed on the body portion 31b of the first housing part 31; and a second portion 20b formed on the second housing part 32. Therefore, in joining the slide member 16 to the first housing part 31, it is possible to cause the slide member 16 to rotate about the rotation axis L1 with the shaft part 25 in abutment with the first portion 20a. Therefore, it is possible to easily rotate the slide member 16 along the inner cover portion 21, meaning that the slide member 16 can be easily joined to the first housing part 31.

Furthermore, in the slide switch mechanism 11 according to the present embodiment, when the operation portion 27 rotates through the predetermined limit angle α in the circumferential direction, the operation portion 27 abuts the circumferential edge portions 19c, 19d of the opening portion 19. This means that the edge portions 19c, 19d play the roles of a stopper in order to restrict the rotation of the slide member 16. This makes it possible to reduce a load that acts on the shaft part 25 when the rotation of the slide member 16 is restricted. Specifically, the distance l1 between the operation portion 27, which acts as a point of effort, and the edge portions 19c, 19d, each of which acts as a fulcrum, can be set small, and the distance l2 between the shaft part 25, which acts as a point of load, and each of the edge portions 19c, 19d can be set large. Specifically, when the shaft part 25 abuts the fixing portion 36, the distance l2 is larger than a distance l3 between the point of effort and the fulcrum, meaning that the load acting on the shaft part 25 can be reduced.

Furthermore, in the slide switch mechanism 11 according to the present embodiment, the labyrinth 30 is formed between the inner cover portion 21 and the slide body 26. Therefore, contaminants can be caught in the area between the inner cover portion 21 and the slide body 26. Furthermore, in the slide switch mechanism 11, the caught contaminants can be brought to the second housing part 32 along the inner cover portion 21. Thus, it is possible to keep the caught contaminants away from the shaft part 25. Therefore, the motion of the shaft part 25 can be protected from impairment caused by contaminants entering the area between the shaft part 25 and the shaft support 20.

Furthermore, in the slide switch mechanism 11 according to the present embodiment, the first projection 21b of the inner cover portion 21 and the second projection 26c of the slide body 26 are positioned next to each other with spacing therebetween in the axial direction to form the labyrinth 30. Therefore, the labyrinth 30 is formed to meander on one side and the other side in a perpendicular direction that is perpendicular to the axial direction on a cross-section perpendicular to the circumferential direction. Therefore, contaminants can be caught in the area between the inner cover portion 21 and the slide body 26.

Furthermore, in the slide switch mechanism 11 according to the present embodiment, the slide body 26 is formed so that the distance between the slide body 26 and the ceiling portion 18a becomes small. Therefore, contaminants are kept from entering the area within the first housing part 31 through the gaps between the slide member 16 and the ceiling portion 18a.

Furthermore, in the slide switch mechanism 11 according to the present embodiment, the outer peripheral edge portion 26b of the slide body 26 is exposed on the one side in the predetermined direction in the opening portion 19 and covers the outer edge portions 19a, 19b of the opening portion 19 that are located at the axially opposite ends thereof. Therefore, in the ceiling portion 18a, contaminants are kept from entering the area within the housing through the area between the slide body 26 and the outer edge portions 19a, 19b of the opening portion 19 that are located at the axially opposite ends thereof.

Furthermore, in the slide switch mechanism 11 according to the present embodiment, the coupling portion 28 is formed so that the distance between the coupling portion 28 and the inner cover portion 21 becomes small in the insertion groove 21a. Therefore, contaminants can be kept from entering the area within the inner cover portion 21 through the gaps between the coupling portion 28 and the inner cover portion 21.

In the slide switch 1 according to the present embodiment, the slide switch 1 includes: the above-described slide switch mechanism 11 further including the spring member 17; and the sensor mechanism 12. Therefore, the slide switch 1 including the above-described functions can be realized.

The operation lever device 2 according to the present embodiment includes the above-described slide switch 1 disposed in an area on the operation lever 5 that is located on the other side in the predetermined direction. Therefore, the operation lever device 2 including the above-described functions can be realized.

### Other Embodiments

In the slide switch mechanism 11 according to the present embodiment, the operation potion 27 is formed having a width equal to the width of the slide body 26, but may be formed having a width less than the width of the slide body 26. The configurations of the sensor mechanism 12 and the spring member 17 are an example; the sensor mechanism 12 and the spring member 17 may have other configurations.

The operation lever device 2 according to the present embodiment is an operation device that operates a work vehicle, but may be an operation device that operates a robot or an operation device for game consoles. Furthermore, a device on which the slide switch 1 according to the present embodiment is provided is not limited to the operation lever device 2; the slide switch 1 according to the present embodiment may be provided on various devices other than the operation device.

### Exemplary Embodiments

A slide switch mechanism according to the first aspect includes: a housing including: a housing body formed to be hollow; an opening portion formed in a ceiling portion of the housing body that is located on one side in a predetermined direction; and an inner cover portion formed inside the housing body to face the ceiling portion and extending in a circumferential direction around a rotation axis passing through the housing body, the inner cover portion being arc-shaped; and a slide member including: a slide body disposed to be rotatable about the rotation axis between the inner cover portion and the ceiling portion; and an operation portion provided on the slide body to project on the one side of the opening portion in the predetermined direction. The housing body is configured to be separable in the predetermined direction into a first housing part and a second housing part. The first housing part includes: a body portion in which the opening portion and the inner cover portion are formed and an insertion path is formed extending on one side in the circumferential direction from the opening portion; and a lid portion that is attached to the body portion to close the insertion path. The second housing part is joined to the first housing part from the other side in the predetermined direction. The slide member causes the operation portion to pass through the insertion path from the one side in the circumferential direction and is joined to the first housing part with the lid portion detached from the body portion.

According to this aspect, the insertion path extending on the one side in the circumferential direction from the opening portion is formed in the body portion of the first housing part. The slide member causes the operation portion to pass through the insertion path from the one side in the circumferential direction and is joined to the first housing part with the lid portion detached from the body portion. Thus, the slide member is joined to the housing as follows, for example. Specifically, the slide member is joined to the housing by rotating about the rotation axis along the inner cover portion. In other words, when the slide member rotates in the other circumferential direction along the inner cover portion, the operation portion is sent toward the opening portion through the insertion path. Thereafter, the lid portion is attached to the body portion and as a result, the insertion path is closed. Furthermore, the second housing part is joined to the first housing part from the other side in the predetermined direction. In this manner, the slide member can be joined to the housing and thus, the slide switch mechanism in which the slide member includes the operation portion can be easily assembled while the increase in the number of components therein is suppressed. In other words, when the inner cover portion is formed in the first housing part, it is possible to easily assemble the slide switch mechanism in which the slide member includes the operation portion while suppressing the increase in the number of components therein.

In a slide switch mechanism according to the second aspect, in the slide switch mechanism according to the first aspect, the housing further includes a shaft support covered by the inner cover portion inside the housing body from the one side in the predetermined direction and formed about the rotation axis that is predetermined, the slide member further includes a shaft part that pivots on the shaft support to be rotatable about the rotation axis and rotates in conjunction with the slide body, and the shaft support includes: a first portion formed on the body portion of the first housing part; and a second portion formed on the second housing part.

According to this aspect, the slide member further includes the shaft part that pivots on the shaft support to be rotatable about the rotation axis and rotates in conjunction with the slide body. The shaft support includes: the first portion formed on the body portion of the first housing part; and the second portion formed on the second housing part. Therefore, in joining the slide member to the first housing part, it is possible to cause the slide member to rotate about the rotation axis with the shaft part in abutment with the first portion. Therefore, it is possible to easily rotate the slide member along the inner cover portion, meaning that the slide member can be easily joined to the first housing part.

In a slide switch mechanism according to the third aspect, in the slide switch mechanism according to the second aspect, the operation portion abuts a circumferential edge portion of the opening portion when the slide member rotates through a predetermined limit angle in the circumferential direction.

According to this aspect, when the slide member rotates through the predetermined limit angle in the circumferential direction, the operation portion abuts the circumferential edge portion of the opening portion. This means that the edge portion plays the roles of a stopper in order to restrict the rotation of the slide member. This makes it possible to reduce a load that acts on the shaft part when the rotation of the slide member is restricted. Specifically, the distance between the operation portion acting as a point of effort and the edge portion acting as a fulcrum can be set small, and the distance between the shaft part acting as a point of load and the edge portion can be set large. Therefore, it is possible to reduce a load that acts on the shaft part.

In a slide switch mechanism according to the fourth aspect, in the slide switch mechanism according to any one of the first to third aspects, the inner cover portion and the slide body form a labyrinth therebetween.

According to this aspect, the labyrinth is formed between the inner cover portion and the slide body. Therefore, contaminants can be caught in the area between the inner cover portion and the slide body.

In a slide switch mechanism according to the fifth aspect, in the slide switch mechanism according to the fourth aspect, the inner cover portion includes a first projection extending in the circumferential direction and projecting toward the slide body, the slide body includes a second projection extending in the circumferential direction and projecting toward the inner cover portion, and the first projection and the second projection are positioned next to each other with spacing therebetween in the axial direction to form the labyrinth.

According to this aspect, the first projection of the inner cover portion and the second projection of the slide body are positioned next to each other with spacing therebetween in the axial direction to form the labyrinth. Therefore, the labyrinth is formed to meander on one side and the other side in a perpendicular direction that is perpendicular to the axial direction on a cross-section perpendicular to the circumferential direction. Therefore, contaminants can be caught in the area between the inner cover portion and the slide body.

In a slide switch mechanism according to the sixth aspect, in the slide switch mechanism according to any one of the first to fifth aspects, the slide body includes an outer peripheral edge portion formed to be wider in an axial direction than an inner peripheral edge portion on axially opposite side surfaces, and the outer peripheral edge portion of the slide body is exposed on the one side in the predetermined direction in the opening portion and covers an outer edge portion of the opening portion that is located at axially opposite ends thereof.

According to this aspect, the outer peripheral edge portion of the slide body is exposed on the one side in the predetermined direction in the opening portion and covers the outer edge portion of the opening portion that is located at the axially opposite ends thereof. Therefore, in the ceiling portion, contaminants are kept from entering the area within the housing through the area between the slide body and the outer edge portion of the opening portion that is located at the axially opposite ends thereof.

A slide switch according to the seventh aspect includes: the slide switch mechanism according to any one of the first to sixth aspects; and a sensor mechanism that detects an amount of rotation of the slide member. The slide switch mechanism further includes a biasing member that biases, in the circumferential direction, the slide member that rotates from a neutral position that is predetermined, and brings the slide member back to the neutral position.

According to this aspect, the slide switch includes: the above-described slide switch mechanism further including the spring member; and the sensor mechanism. Therefore, the slide switch including the above-described functions can be realized.

An operation lever device according to the eighth aspect includes: an operation lever extending in a predetermined direction and pivotally supported at an end on one side in the predetermined direction; and the slide switch according to the seventh aspect. The slide switch is disposed in an area on the operation lever that is located on the other side in the predetermined direction.

According to this aspect, the operation lever device includes the above-described slide switch disposed in an area on the operation lever that is located on the other side in the predetermined direction. Therefore, the operation lever device including the above-described functions can be realized.

From the foregoing description, many modifications and other embodiments of the present disclosure would be obvious to a person having ordinary skill in the art. Therefore, the foregoing description should be interpreted only as an example and is provided for the purpose of teaching the best mode for carrying out the present disclosure to a person having ordinary skill in the art. Substantial changes in details of the structures and/or functions of the present disclosure are possible within the spirit of the present disclosure.

1. A slide switch mechanism comprising:
a housing including: a housing body formed to be hollow; an opening portion formed in a ceiling portion of the housing body that is located on one side in a predetermined direction; and
an inner cover portion formed inside the housing body to face the ceiling portion and extending in a circumferential direction around a rotation axis passing through the housing body, the inner cover portion being arc-shaped; and
a slide member including: a slide body disposed to be rotatable about the rotation axis between the inner cover portion and the ceiling portion; and an operation portion provided on the slide body to project on the one side of the opening portion in the predetermined direction, wherein:
the housing body is configured to be separable in the predetermined direction into a first housing part and a second housing part;
the first housing part includes: a body portion in which the opening portion and the inner cover portion are formed and an insertion path is formed extending on one side in the circumferential direction from the opening portion; and a lid portion that is attached to the body portion to close the insertion path;
the second housing part is joined to the first housing part from the other side in the predetermined direction; and
the slide member causes the operation portion to pass through the insertion path from the one side in the circumferential direction and is joined to the first housing part with the lid portion detached from the body portion.

2. The slide switch mechanism according to claim 1, wherein:
the housing further includes a shaft support covered by the inner cover portion inside the housing body from the one side in the predetermined direction and formed about the rotation axis that is predetermined;
the slide member further includes a shaft part that pivots on the shaft support to be rotatable about the rotation axis and rotates in conjunction with the slide body; and
the shaft support includes: a first portion formed on the body portion of the first housing part; and a second portion formed on the second housing part.

3. The slide switch mechanism according to claim 2, wherein:
the operation portion abuts a circumferential edge portion of the opening portion when the slide member rotates through a predetermined limit angle in the circumferential direction.

4. The slide switch mechanism according to claim 1, wherein:
the inner cover portion and the slide body form a labyrinth therebetween.

5. The slide switch mechanism according to claim 4, wherein:
the inner cover portion includes a first projection extending in the circumferential direction and projecting toward the slide body;
the slide body includes a second projection extending in the circumferential direction and projecting toward the inner cover portion; and
the first projection and the second projection are positioned next to each other with spacing therebetween in an axial direction to form the labyrinth.

6. The slide switch mechanism according to claim 1, wherein:
the slide body includes an outer peripheral edge portion formed to be wider in an axial direction than an inner peripheral edge portion on axially opposite side surfaces; and
the outer peripheral edge portion of the slide body is exposed on the one side in the predetermined direction in the opening portion and covers an outer edge portion of the opening portion that is located at axially opposite ends thereof.

7. A slide switch comprising:
the slide switch mechanism according to claim 1; and
a sensor mechanism that detects an amount of rotation of the slide member, wherein:
the slide switch mechanism further includes a biasing member that biases, in the circumferential direction, the slide member that rotates from a neutral position that is predetermined, and brings the slide member back to the neutral position.

8. An operation lever device comprising:
an operation lever extending in a predetermined direction and pivotally supported at an end on one side in the predetermined direction; and
the slide switch according to claim 7, wherein:
the slide switch is disposed in an area on the operation lever that is located on the other side in the predetermined direction.
